(19) United States
(12) Patent Application Publication
(10) Pub. No.: US 2021/0287566 A1
(43) Pub. Date: Sep. 16, 2021

(54) TWO-DIGIT NUMBER ARITHMETIC OPERATION DISPLAY DEVICE FOR MULTI-TASKING TRAINING

(71) Applicant: Dongeun LEE, Gyeryong-si, Chungcheongnam-do (KR)

(72) Inventors: Dongeun LEE, Gyeryong-si (KR); Seonkyoung KIM, Daejeon (KR)

(21) Appl. No.: 16/491,538

(22) PCT Filed: Jun. 12, 2018
(86) PCT No.: PCT/KR2018/006622

§ 371 Date: Sep. 5, 2019

(30) Foreign Application Priority Data
Jun. 15, 2017 (KR) 10-2017-0075780

(51) Int. Cl. G09B 19/02; G09B 5/02

(52) U.S. Cl. CPC G09B 19/02; G09B 5/02

(57) ABSTRACT

The present invention relates to a two-digit number arithmetic operation display device for multi-tasking training and, more specifically, to a two-digit number arithmetic operation display device for multi-tasking training, the device presenting a method enabling easy calculation of an arithmetic operation process, which uses a two-digit number, among arithmetic operation processes such as addition and subtraction, and providing a multi-tasking environment, thereby enabling infants or children to easily remember a two-digit number arithmetic operation method, so as to facilitate training and acquisition of a two-digit number arithmetic operation by children.

### TECHNICAL FIELD

The present invention relates to a display device for multitasking training that enables youngsters and children to easily practice and master two-digit number arithmetic operations. It accomplishes this by presenting a method for easily adding and subtracting with two-digit numbers.

### BACKGROUND ART

In general, children can easily learn arithmetic operations when taught with single-digit numbers.

However, when they are taught two-digit number arithmetic operations, children often have difficulty in acquiring the operations due to the increased number of digits. Children often confuse digits or require more instructional time to understand the concepts.

In other words, with current instructional methods, children learn operations with two or more-digit numbers at a slower pace than with single-digit numbers. This learning process results in greater time dedicated to learning these types of operations and thus can potentially negatively affect children's attitudes towards mathematics.

In this regard, the conventional arithmetic operation techniques include descending and ascending order calculations.

These operations can easily exhaust children with boring and monotonous calculations that can cause children to lose interest in learning arithmetic operations and have difficulty in understanding various characteristics of numbers.

Therefore, in recent years, there has been a need for development of learning techniques and learning apparatuses that enable children to learn addition and subtraction more easily and become familiar with arithmetic. This familiarity can improve children's ability to perform arithmetic operations.

Finally, learning techniques that can cultivate human ability to learn and reason in multiple modes is vital in the modern era. In preparation for the coming era of artificial intelligence, it is necessary to help people develop their ability to understand and utilize artificial intelligence at a young age. Therefore, a learning method for developing abilities based on multi-distributed processing (hereinafter referred to as “multitasking”) is needed.

### LEADING TECHNICAL LITERATURE

(Patent Document 1) Korean Patent No. 10-1071969 (Oct. 4, 2011)

(Patent Document 2) (Prior Art Document 1) Research on Human Behavior System based on Brain Information Mechanism (Subtitle: Research on Self-Learning and Multi-Distributed Intelligence Model, Research Institute: Chung-Ang University, Project under Ministry of Science and Technology, July 2004 Report)

### DISCLOSURE

### Technical Problem

Therefore, the present invention has been made in view of the above problems.

It is one object of the present invention to provide a two-digit number arithmetic operation display device for multitasking training which presents a two-digit number arithmetic operation that can be easily approached by children such that children can easily approach and master two-digit number arithmetic operations without difficulty.

It is another object of the present invention to provide a two-digit number arithmetic operation display device for multitasking training which can improve children's creativity and problem-solving ability by presenting associative methods that are easy to associate with arithmetic operations such that the children can use the methods.

It is another object of the present invention to enable fast arithmetic operations through multitasking training by visualizing the arithmetic operations.

### Technical Solution

In accordance with one aspect of the present invention, provided is an arithmetic operation display device for multitasking training, including:

a table generation display unit 100 configured to generate a table by sequentially arranging one or more blocks B and to sequentially display numbers from 1 to 100 in the blocks B sequentially arranged in the generated table;

a presented number display unit 200 configured to generate two terms and display, in the generated terms, any two-digit numbers or two-digit numbers input by a user in order to perform an arithmetic operation of the two-digit numbers;

a primary total sum display unit 300 configured to extract, from the table displayed on the table generation display unit 100, a number corresponding to each of the two-digit numbers input to the presented number display unit 200, change the extracted number such that a following digit of the extracted number becomes ‘5’, then calculate and display a sum of the changed two-digit numbers;

a primary units-place total sum display unit 400 configured to calculate a signed difference between each of the changed two-digit numbers having the following digit set to ‘5’ and each of the two-digit numbers input to the presented number display unit 200 and to calculate and display a sum of the differences including a sign; and

an integrated total sum display unit 500 configured to display the sum of the two-digit numbers calculated by the primary total sum display unit 300 and the differences including the sign calculated by the primary units-place total sum display unit 400, the sum of the two-digit numbers and the sum of the differences being calculated and displayed.

In accordance with yet another aspect of the present invention, provided is a module for developing multi-distributed intelligence by multitasking configured to operate the primary total sum display unit and the primary units-place total sum display unit for training.

### Advantageous Effects

According to the above-described configuration, the two-digit number arithmetic operation display device for multitasking training of the present invention may achieve the following effects.

As a two-digit number arithmetic operation that can be easily approached by children is presented, children can easily approach and master two-digit number arithmetic operations without feeling objection to the two-digit number arithmetic operations.

In addition, associative methods that are easy to associate with arithmetic operations are presented such that the children can use the methods. Thereby, children's creativity and problem solving ability can be improved.

Further, the present invention can enhance preschoolers' multitasking arithmetic operation capability of multiples of 5 and an arithmetic operation of single-digit numbers at the same time, thereby adapting the children to future jobs requiring multitasking.

### DESCRIPTION OF DRAWINGS

FIG. 1 is a diagram of an overall structure of a two-digit number arithmetic operation display device for multitasking training according to an embodiment of the present invention.

FIG. 2 is a diagram of an overall configuration of the two-digit number arithmetic operation display device for multitasking training according to the embodiment of the present invention.

FIG. 3 shows an exemplary table generated by a table generation display unit 100 of the two-digit number arithmetic operation display device for multitasking training according to the embodiment of the present invention.

FIG. 4 is a detailed configuration diagram of a presented number display unit 200 of the two-digit number arithmetic operation display device for multitasking training according to the embodiment of the present invention.

FIG. 5 is a detailed configuration diagram of a primary total sum display unit 300 of the two-digit number arithmetic operation display device for multitasking training according to the embodiment of the present invention.

FIG. 6 is a detailed configuration diagram of a primary units-place total sum display unit 400 of the two-digit number arithmetic operation display device for multitasking training according to the embodiment of the present invention.

FIG. 7 is a detailed configuration diagram of an integrated total sum display unit 500 of the two-digit number arithmetic operation display device for multitasking training according to the embodiment of the present invention.

### BEST MODE

Various modifications and changes can be made to the present invention, and embodiments are disclosed in detail in the following description with reference to the accompanying drawings. It should be understood, however, that the invention is not intended to be limited to the particular embodiments disclosed, but includes all modifications, equivalents, and alternatives falling within the spirit and scope of the invention. These embodiments are provided to explain in detail the present invention to those skilled in the art. Therefore, the shape of each element shown in the drawings may be exaggerated for clarity. Further, in the following description of the present invention, a detailed description of known art incorporated herein will be omitted when it may obscure the subject matter of the present invention.

Terms such as first and second may be used to describe various components, but the components should not be limited by the terms. The terms are only used to distinguish one component from another.

The terminology used herein is for the purpose of describing particular embodiments and is not intended to limit the present invention. Singular expressions include plural expressions unless the context clearly indicates otherwise.

In the present application, the term “comprising”, “having”, or the like is intended to specify the presence of stated features, numbers, steps, operations, elements, parts, or combinations thereof, but should not be construed as precluding the presence or addition of one or more other features, numbers, steps, operations, elements, parts, or combinations thereof.

In the present invention, a “table generated by a table generation display unit 100” may be referred to as a “multitasking arithmetic operation table.”

Hereinafter, preferred embodiments of the present invention will be described in detail with reference to the accompanying drawings.

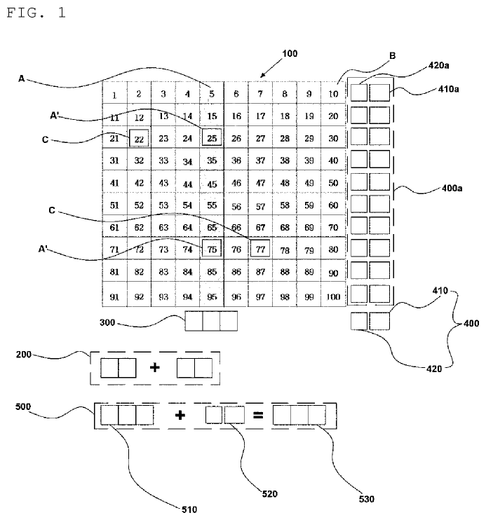

FIG. 1 is a diagram of an overall structure of a two-digit number arithmetic operation display device for multitasking training according to an embodiment of the present invention.

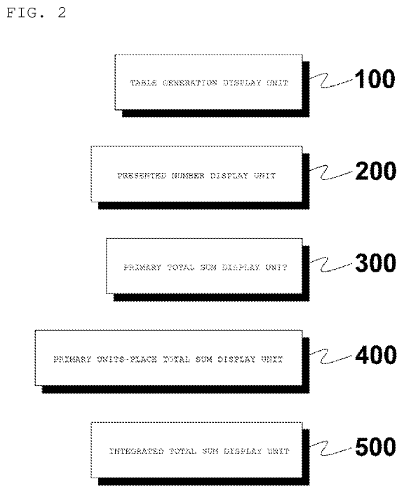

FIG. 2 is a diagram of overall configuration of the two-digit number arithmetic operation display device for multitasking training according to the embodiment of the present invention.

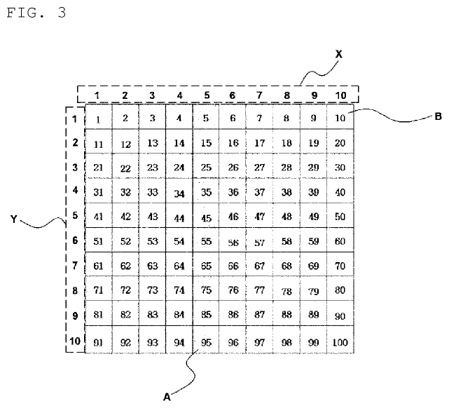

FIG. 3 shows an exemplary table generated by the table generation display unit 100 of the two-digit number arithmetic operation display device for multitasking training according to the embodiment of the present invention.

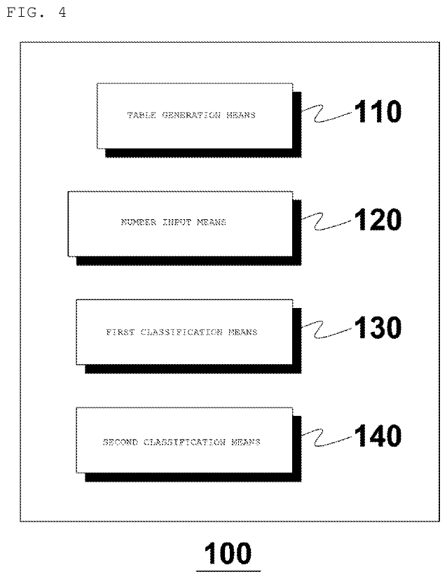

FIG. 4 is a detailed configuration diagram of a presented number display unit 200 of the two-digit number arithmetic operation display device for multitasking training according to the embodiment of the present invention.

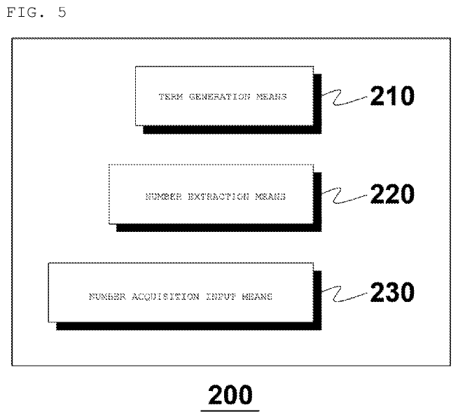

FIG. 5 is a detailed configuration diagram of a primary total sum display unit 300 of the two-digit number arithmetic operation display device for multitasking training according to the embodiment of the present invention.

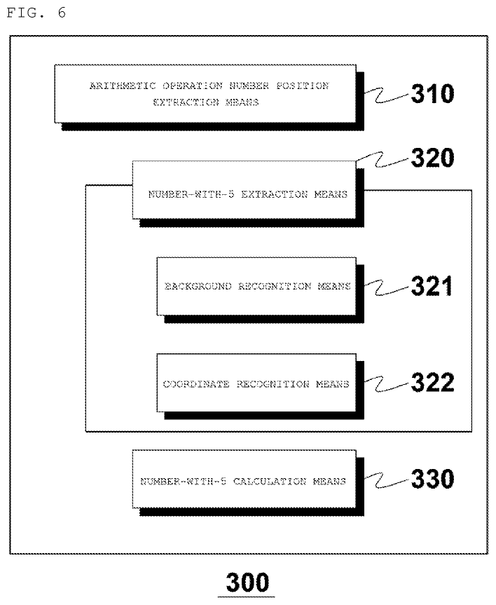

FIG. 6 is a detailed configuration diagram of a primary units-place total sum display unit 400 of the two-digit number arithmetic operation display device for multitasking training according to the embodiment of the present invention.

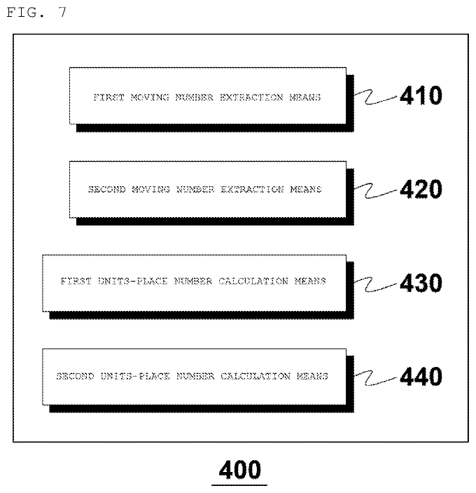

FIG. 7 is a detailed configuration diagram of an integrated total sum display unit 500 of the two-digit number arithmetic operation display device for multitasking training according to the embodiment of the present invention.

Referring FIGS. 1 to 7, the two-digit number arithmetic operation display device for multitasking training includes:

a table generation display unit 100 configured to generate a table by sequentially arranging one or more blocks B and to sequentially display numbers from 1 to 100 in the blocks B sequentially arranged in the generated table;

a presented number display unit 200 configured to generate two terms and display, in the generated terms, any two-digit numbers or two-digit numbers input by a user in order to perform an arithmetic operation on the two-digit numbers;

a primary total sum display unit 300 configured to extract, from the table displayed on the table generation display unit 100, a number corresponding to each of the two-digit numbers input to the presented number display unit 200, change the extracted number such that a following digit of the extracted number becomes ‘5’, then calculate and display a sum of the changed two-digit numbers;

a primary units-place total sum display unit 400 configured to calculate a signed difference between each of the changed two-digit numbers having the following digit set to ‘5’ and each of the two-digit numbers input to the presented number display unit 200 and to calculate and display a sum of the differences including a sign; and

an integrated total sum display unit 500 configured to display the sum of the two-digit numbers calculated by the primary total sum display unit 300 and the differences including the sign calculated by the primary units-place total sum display unit 400, the sum of the two-digit numbers and the sum of the differences being calculated and displayed.

The primary total sum display unit 300 and the primary units-place total sum display unit 400 may be implemented in a multitasking mode enabling simultaneous operation thereof.

The table generation display unit 100 is configured to generate a table by sequentially arranging one or more blocks B and to sequentially display numbers from 1 to 100 in the blocks B sequentially arranged in the generated table.

The table generation display unit 100 includes:

a table generation means 110 configured to generate the one or more blocks B and generate a table by arranging the generated blocks B in ten columns and ten or fewer rows;

a number input means 120 configured to arrange and input numbers from 1 in a row direction, starting in a top leftmost block B among the block B of the table generated by the table generating means 110;

a first classification means 130 configured to store the blocks B by filling the background of the blocks B with an input number having a units digit set to 5 with a color A when the numbers starting with 1 are arranged and input in the table generated by the table generation means 110; and

a second classification means 140 configured to assign a coordinate value to each of the blocks B included in the table generated by the table generation means 110 and store the coordinate values, by inputting horizontal coordinates from 1 to 10 in a horizontal direction with respect to the top leftmost block B and vertical coordinates from 0 to 9 in a vertical direction with respect to the top leftmost block B in the table.

The table generation means 110 is configured to arrange the blocks B in ten columns and ten or fewer rows. Accordingly, the maximum number of blocks B that can be generated is 100.

This configuration is intended to limit the arithmetic operations to two-digit numbers, to which the present invention is directed. When the number of blocks exceeds 100, the operations become three-digit number operations.

The first classification means 130 is configured to store the blocks B by filling the background of the blocks B with an input number having a units digit set to 5 with a color. Here, the numbers having a units digit set to 5 refers 5, 15, 25, 35, 45, 55, . . . , and 95.

Configuring the first classification means 130 to store the blocks B by filling the background of the blocks B with an input number having a units digit set to 5 with a color is intended to set a reference to perform calculation based on the numbers having a units digit set to 5.

The presented number display unit 200 is configured to generate two terms and display, in the generated terms, any two-digit numbers or two-digit numbers input by a user in order to perform an arithmetic operation of the two-digit numbers.

The presented number display unit 200 includes a block marking means C configured to place a visual mark on a block B corresponding to a two-digit number input in the terms among the blocks B in which numbers are input in the table generated by the table generation display unit 100.

The visual mark refers to a mark differentiating the block from other blocks by, for example, lighting or coloring the block.

The presented number display unit 200 includes at least one of:

a term generation means 210 configured to generate two or more terms, the term generation means allowing the user to selectively adjust the number of terms;

a number extraction means 220 configured to extract any two-digit number from the table with the input numbers generated by the table generating display unit 100 according to the number of terms generated by the term generation means 210; and

a number acquisition input means 230 configured to allow the user to input a two-digit number according to the number of terms generated by the term generation means 210.

Accordingly, the user is allowed to control the number of terms to be calculated and input a two-digit number on which calculation is to be performed, or a two-digit number can be randomly generated.

The primary total sum display unit 300 is configured to extract, from the table displayed on the table generation display unit 100, a number corresponding to each of the two-digit numbers input to the presented number display unit 200, change the extracted number such that a following digit of the extracted number becomes ‘5’, then calculate and display a sum of the changed two-digit numbers.

The primary total sum display unit 300 includes a block marking means A′ configured to make a visual mark on a block B corresponding to a two-digit number that is changed to have a following digit set to ‘5’ among the blocks B in which numbers are input in the table generated by the table generation display unit 100.

The visual mark refers to a mark differentiating the block from other blocks by, for example, lighting or coloring the block.

The primary total sum display unit 300 includes at least one of:

an arithmetic operation number position extraction means 310 configured to extract, from the table stored in the table generation display unit 100, a position corresponding to each of the two-digit numbers input to the arithmetic operation number presentation unit by comparing the two-digit numbers with the table;

a number-with-5 extraction means configured to extract a position of a number with 5 in a row where each of the two-digit numbers extracted by the arithmetic operation number position extraction means 310 is located in the table;

a number-with-5 calculation means 330 configured to derive a calculated value of the sum of the numbers with 5 at the positions of the numbers with 5 extracted from the number-with-5 extraction means 320.

In this regard, referring to FIG. 1, for example, when ‘77’ and ‘22’ are input to the two terms input to the presented number display unit 200, respectively, the number with 5 in a row corresponding to ‘77’ is ‘75’, and the number with 5 in a row corresponding to ‘22’ is ‘25’. Accordingly, the sum of ‘75’ and ‘25’ is calculated.

In other words, by calculating ‘75+25’, a calculated value of ‘100’ is derived.

The number-with-5 extraction means 320 includes at least one of:

a background recognition means 321 configured to recognize a color of the background of the block B having the input number with the units digit set to 5 in the first classification means 130 to extract, from the table, a position of a number with 5 in a row where each of the two-digit numbers whose positions are extracted by the arithmetic operation number position extraction means 310 is located; and

a coordinate recognition means 322 configured to extract, from the table stored in the second classification means 140, a coordinate value of the number with 5 in the row where each of the two-digit numbers whose positions are extracted by the arithmetic operation number position extraction means 310 is located, using a coordinate value of each block B in the table.

As described above, in the number-with-5 extraction means 320, the background recognition means 321 recognizes the color of the blocks in which the numbers with 5 are located in the table and extracts the positions of the numbers with 5, and the coordinate recognition means 322 extracts the coordinate values of the positions of the numbers with 5 using the coordinate values assigned to the blocks B of the table.

As an example of extracting the coordinate values, referring to FIG. 3, when the input number is ‘77’, the coordinates of ‘77’ are (7, 6) and the number with 5 in the row having ‘77’ is ‘75’. Accordingly, the position of the number with 5 is determined by extracting (5, 6), which is the coordinates of ‘75’.

The primary units-place total sum display unit 400 is configured to calculate a signed difference between each of the changed two-digit numbers having the following digit set to ‘5’ and each of the two-digit numbers input to the presented number display unit 200 and to calculate and display a sum of the differences including a sign.

The primary units-place total sum display unit 400 configured to calculate a signed difference between each of the changed two-digit numbers having the following digit set to ‘5’ and each of the two-digit numbers input to the presented number display unit 200 and to calculate and display a sum of the differences including a sign includes:

a sign display unit 420 configured to display a sign, and a difference-sum display unit 410 configured to display the sum of the differences.

The primary units-place total sum display unit 400 includes a units-place display means 400a displayed at one side end of the table generation display unit 100, the units-place display means 400a including a sign display means 420a configured to display a sign of a calculated value for the signed difference between each of the changed two-digit numbers having the following digit set to ‘5’ and each of the two-digit numbers input to the presented number display unit 200, and a difference display means 410a configured to display the difference.

The primary units-place total sum display unit 400 includes at least one of:

a first moving number extraction means 410 configured to acquire a difference including a sign by comparing each of the two-digit numbers input to the presented number display unit 200 with the numbers with 5 obtained by changing the units digit of the two-digit numbers to ‘5’ by the primary total sum display unit 300;

a second moving number extraction means 420 configured to acquire a horizontal moving value by comparing the horizontal coordinate X of the number with 5 extracted by the coordinate recognition means 322 with the horizontal coordinate X of each of the two-digit numbers input to the presented number eight display unit 200 according to coordinates of each block B of the second classification means 140, the second moving number extraction means 420 assigning a ‘+’ sign to the horizontal moving value when the horizontal coordinate X of the number with 5 extracted by the coordinate recognition means 322 is less than the horizontal coordinate X of each of the two-digit numbers input to the presented number display unit 200 and assigning a ‘−’ sign to the horizontal moving value when the horizontal coordinate X of the number with 5 extracted by the coordinate recognition means 322 is greater than the horizontal coordinate X of each of the two-digit numbers;

a first units-place number calculation means 430 configured to derive a units-place calculated value by summing the differences including the sign for the two-digit numbers acquired by the first moving number extraction means 410; and

a second units-place number calculation means 440 configured to derive a units-place calculated value by summing the differences including the sign for the two-digit numbers acquired by the second moving number extraction means 420.

Regarding the first moving number extraction means 410, an example will be described.

When the input two-digit numbers are ‘77’ in the first term and ‘22’ in the second term, the number with 5 for ‘77’ input in the first term is ‘75’ and the difference of ‘77’ from 75’ is ‘+2’.

The number with 5 for ‘22’ input in the second term is ‘25’, and the difference of ‘22’ from ‘25’ is ‘−3’.

That is, a sign is assigned by determining whether the input two-digit number has a positive (+) value or a negative (−) value with respect to a single digit 5.

As a result, ‘−1’ is derived by summing the respective differences ‘+2’ and ‘−3’ ((+2)+(−3)).

Regarding the second moving number extraction means 420, an example will be described.

When the input two-digit numbers are ‘77’ in the first term and ‘22’ in the second term, the horizontal coordinate X (x coordinate value) of ‘77’ input in the first term is ‘7’, and the horizontal coordinate X of ‘75’, which is the number with 5 for ‘77’, is ‘5’. Accordingly, the horizontal coordinate X of the first term is greater than the horizontal coordinate X of the number with 5, and the difference therebetween is ‘2’. Therefore, a ‘+’ sign is assigned and thus ‘+2’ is obtained.

The horizontal coordinate X (x coordinate value) of ‘22’ input in the second term is ‘2’, and the horizontal coordinate X of ‘25’, which is the number with 5 for ‘22’, is ‘5’. Accordingly, the horizontal coordinate X of the second term is less than the horizontal coordinate X of the number with 5, and the difference therebetween is ‘3’. Therefore, a ‘−’ sign is assigned and thus ‘−3’ is obtained.

That is, a sign is assigned by determining whether the value in the units place of the input two-digit number is greater or less than the horizontal coordinate X of the number with 5.

Accordingly, ‘−1’ is derived by summing the horizontal shift values of ‘+2’ and ‘−3’ ((+2)+(−3)).

The integrated total sum display unit 500 is configured to display the sum of the two-digit numbers calculated by the primary total sum display unit 300 and the differences including a sign calculated by the primary units-place total sum display unit 400, the sum of the two-digit numbers and the sum of the differences being calculated and displayed.

The integrated total sum display unit 500 includes: a primary sum display unit 510 configured to display the sum of the two-digit numbers calculated by the primary total sum display unit 300;

a primary units-place sum display unit 520 configured to display the difference including a sign calculated by the primary units-place total sum display unit 400; and

an integrated value display unit 530 configured to calculate and display the sum of the two-digit numbers displayed on the primary sum display unit 510 and the sum of the differences displayed on the first units-place sum display unit 520.

Regarding the integrated total sum display unit 500, an example will be described. When the presented number display unit 200 generates two terms and inputs ‘77’ in the first term and ‘22’ in the second term, a ‘+’ is input in the operator presentation unit 300, the primary total sum display unit 300 derives ‘100’ by summing ‘75’, which is the number with 5 for the first term, and ‘25’, which is the number with 5 for the second term (75+22).

In addition, the primary units-place total sum display unit 400 derives ‘−1’ by summing the signed difference ‘+2’ between which is the number in the units place of ‘77’ in the first term, and ‘5’, which is the number in the units place of the number with 5 for the first term, and

the signed difference ‘−3’ between ‘2’, which is the number in the units place of ‘22’ in the second term, and ‘5’, which is the number in the units place of the number with 5 for the second term.

Thus, ‘99’ is derive by adding (+) ‘100’ derived by the primary total sum display unit 300 and ‘−1’ derived by the primary units-place total sum display unit 400.

Here, the derivation process of deriving ‘100’ in the primary total sum display part 300 and the process of deriving ‘−1’ in the primary units-place total sum display unit 400 are employed in the multitasking training, and it is important to create a multitasking environment.

The primary total display unit 300 enables users mastery of addition of multiples of 5 by training in a short period of time without a deep computational thinking function, and the primary units-place total sum display unit 400 performs an operation involving a sensory organ of visual perception. Accordingly, these units are modules that can proceed simultaneously by training.

In short, the value of ‘77+22’ is 99 and the value calculated in the manner described above is 99. Therefore, the calculated value is correct.

The calculation is performed in the above-described manner for the following reason. A calculation result having ‘0’ in the units place is easily obtained by performing the calculation based on 5, and accordingly children or youngsters can much easily perform arithmetic operations on two-digit numbers. Since calculation related to two-digit numbers can be easily performed, the calculation is configured as described above.

In addition, the primary sum display unit 510 and the primary units-place sum display unit 520 can be operated simultaneously according to training, thereby cultivating a multitasking ability for arithmetic operations.

The primary sum display unit 510 enables users to immediately calculate and derive the sum of two numbers that are multiples of 5 by training, and the primary units-place sum display unit 520 enables users to perform the calculation simply by looking up the multitasking arithmetic operation table of the present invention. The primary sum display unit 510 and the primary units-place sum display unit 520 can be implemented as simple processors, thus enable multitasking. By repeatedly practicing with the display units, a good multitasking ability may be cultivated.

Therefore, it is important to design the primary total sum display unit 300 and the primary units-place total sum display 400 so as to perform arithmetic operations simultaneously.

According to the above-described configuration, the present invention can display the process of performing calculation on the numbers so that children can visually recognize the process of two-digit number arithmetic operation. Therefore, children can easily and rapidly understand and master two-digit number arithmetic operations.

In other words, the entire processes are visually provided and a calculation process of two-digit numbers using the table and the above-mentioned calculation method is provided. Thereby, the children's understanding of the two-digit number arithmetic operation can be improved.

According to the above-described configuration, the two-digit number arithmetic operation display device for multitasking training of the present invention has the following effects.

By presenting an easily approachable method among two-digit number arithmetic operation methods, children can easily approach and master the two-digit number arithmetic operation without reluctance.

In addition, an associative method that is easy to associate with arithmetic operation is presented to the children such that the children can use the method. Accordingly, children's creativity and problem-solving ability can be improved.

### INDUSTRIAL APPLICABILITY

The present invention provides provide a two-digit number arithmetic operation display device for multitasking training which can improve children's creativity and problem-solving ability by presenting associative methods that are easy to associate with arithmetic operations such that the children can use the methods, thereby enhancing the multitasking arithmetic operation capability such that the children are adapted to future jobs requiring multitasking. Therefore, the invention will be useful in the field of education and learning.

1. An arithmetic operation display device for multitasking training, comprising:
a table generation display unit (100) configured to generate a table by sequentially arranging one or more blocks (B) and to sequentially display numbers from 1 to 100 in the blocks (B) sequentially arranged in the generated table;
a presented number display unit (200) configured to generate two terms and display, in the generated terms, any two-digit numbers or two-digit numbers input by a user in order to perform an arithmetic operation of the two-digit numbers;
a primary total sum display unit (300) configured to extract, from the table a splayed on the table generation display unit (100), a number corresponding to each of the two-digit numbers input to the presented number display unit (200), change the extracted number such that a following digit of the extracted number becomes ‘5’, then calculate and display a sum of the changed two digit numbers;
a primary units-place total sum display unit (400) configured to calculate a signed difference between each of the changed two-digit numbers having the following digit set to ‘5’ and each of the two-digit numbers input to the presented number display unit (200) and to calculate and display a sum of the differences comprising a sign; and
an integrated total sum display unit (500) configured to display the sum of the two-digit numbers calculated by the primary total sum display unit (300) and the differences including the sign calculated by the primary units-place total sum display unit (400), the sum of the two-digit numbers and the sum of the differences being calculated and displayed,
wherein the primary total sum display unit (300) and the primary units-place total sum display unit (400) are required to perform the arithmetic operation at the same time,
wherein the table generation display unit (100) comprises at least one of:
a table generation means (110) configured to generate the one or more blocks (B) and generate a table by arranging the generated blocks (B) in ten columns and ten or fewer rows;
a number input means (120) configured to arrange and input numbers from ‘1’ in a row direction, starting from a top leftmost block (B) among the block (B) of the table generated by the table generating means (110);
a first classification means (130) configured to store the blocks (B) by filling the background of the blocks (B) with an input number having a units digit set to ‘5’ with a color A when the numbers starting with ‘1’ are arranged and input in the table generated by the table generation means (110); and
a second classification means (140) configured to assign a coordinate value to each of the blocks (B) included in the table generated by the table generation means (110) and store the coordinate values, by inputting horizontal coordinates from ‘1’ to ‘10’ in a horizontal direction with respect to the top leftmost block (B) and vertical coordinates from ‘0’ to ‘9’ in a vertical direction with respect to the top leftmost block (B) in the table.
